(19) United States
(12) Patent Application Publication
(10) Pub. No.: US 2012/0233034 A1
(43) Pub. Date: Sep. 13, 2012

(54) COMBINED TABLE AND COMPUTER-CONTROLLED PROJECTOR UNIT

(75) Inventors: Martin Riddiford, London (GB); Daniel Potter, London (GB); Noel Hunwick, London (GB)

(73) Assignee: Compurants Limited, London (GB)

(21) Appl. No.: 13/391,052

(22) PCT Filed: Aug. 19, 2010
(86) PCT No.: PCT/GB2010/051377

§ 371 Date: May 3, 2012

(30) Foreign Application Priority Data
Aug. 19, 2009 (GB) 0914511.1
Nov. 27, 2009 (GB) 0920754.9

(51) Int. Cl. G03B 21/10; G06Q 30/00; G06Q 50/12; G06F 3/033

(52) U.S. Cl. 705/27.1; 353/28; 345/157

(57) ABSTRACT

A combined table and computer-controlled projector unit, comprises: (a) at least one table; (b) a stand supporting the table; (c) a projector controlled by a computer; and (d) an imaging system mounted on the stand, the imaging system causing an image to be projected onto the table. Because the unit combines both a table and the computer controlled projector unit, it can be readily installed and does not require any ceiling cabling.

### BACKGROUND OF THE INVENTION

1. Field of the Invention

This invention relates to a combined table and computer-controlled projector unit. It may be used in any environment where it is useful to be able to project images onto a surface. It may, for example, be used in an interactive food and/or drink ordering system, in which a computer controlled projector is mounted above a surface such that a menu of food and/or drink selection options is projected onto some or all of the surface. Other environments where the unit may be used include: libraries, internet cafes, and wherever there are advantages to using projected images (as opposed to images from display panels, such as LCD displays).

2. Description of the Prior Art

WO 2008/071979 (the contents of which are incorporated by reference) describes an interactive food and/or drink ordering system, in which a computer controlled projector is mounted above a surface such that a menu of food and/or drink selection options is projected onto some or all of the surface. The selection options are selectable by a user operating an interface device connected to the computer, such as a wireless track pad.

However, this prior art system may require a ceiling mounted projector; this in turn imposes substantial costs since the ceiling has to be adapted for the projectors and the associated cabling.

In many contexts, it is very useful for a restaurant to be able to provide an interactive food and/or drink ordering system of the kind described in WO 2008/071979. However, the investment in fitting out an entire restaurant can be substantial.

### SUMMARY OF THE INVENTION

This invention is a combined table and computer-controlled projector unit, comprising:

(a) at least one table;

(b) a stand connected to the table;

(c) a projector controlled by a computer;

(d) an imaging system mounted on the stand, the imaging system causing an image to be projected onto the table.

Because the unit combines both a table and the computer controlled projector unit, it can be readily installed and does not require any ceiling cabling.

### BRIEF DESCRIPTION OF THE DRAWINGS

The invention will be described with reference to the accompanying Figures:

FIG. 1 which is a perspective view of a combined table and computer-controlled projector unit, as defined in this invention;

FIG. 2 is another perspective view of a combined table and computer-controlled projector unit;

FIG. 3 is a schematic of the main elements of the unit when used as part of an interactive food and/or drink ordering system;

FIGS. 4, 5, 6 and 7 are illustrations of various implementations.

### DETAILED DESCRIPTION

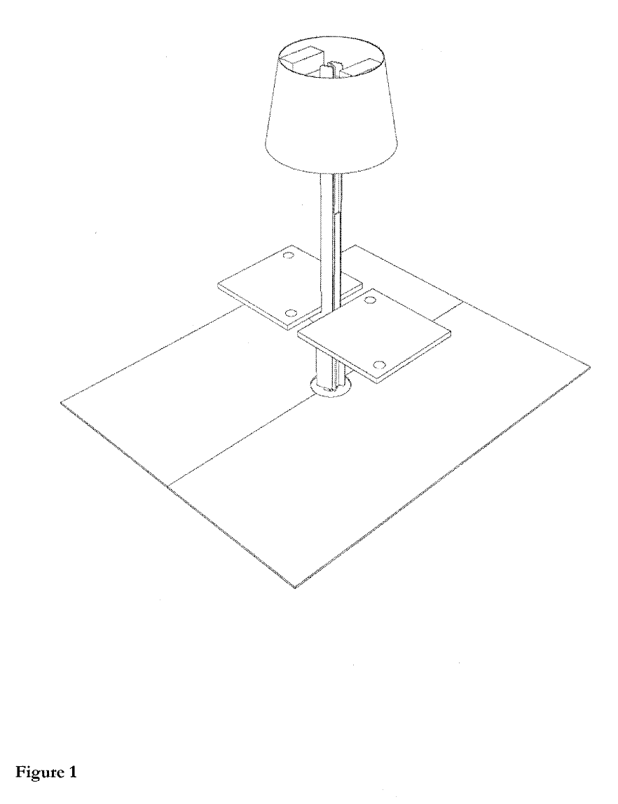

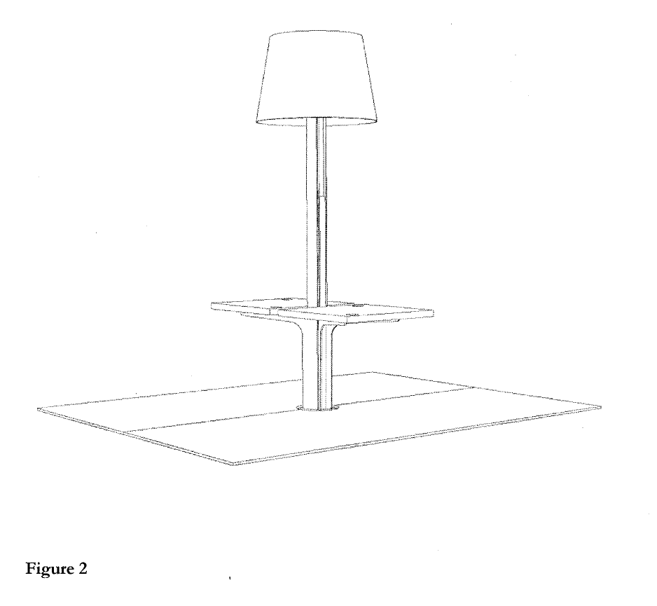

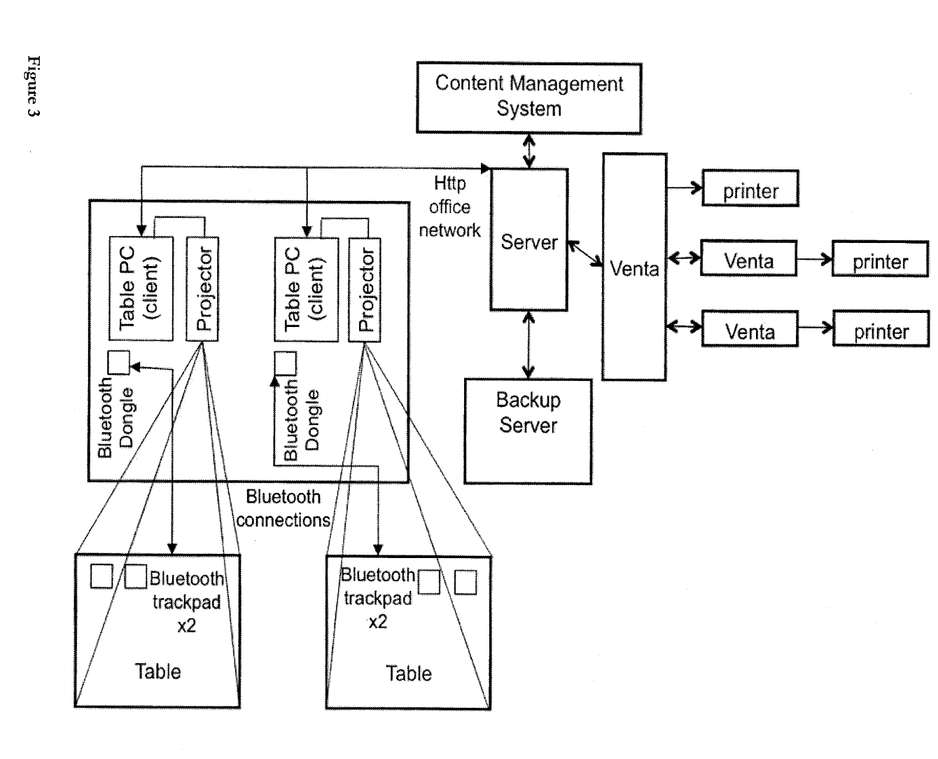

Referring to FIGS. 1 and 2, there is shown an example of a combined table and computer-controlled projector unit, as defined in this invention. The unit, referred to as the E-Table™, includes a vertical stand, supporting two tables and two projector units at the top of the stand (a single projector can also be used) projecting images onto each table, as shown in FIG. 7. In this example, the imaging system is the projector; the projector can then be mounted on the stand and positioned above the table, surrounded by a shade. One or more projectors may be mounted on the stand.

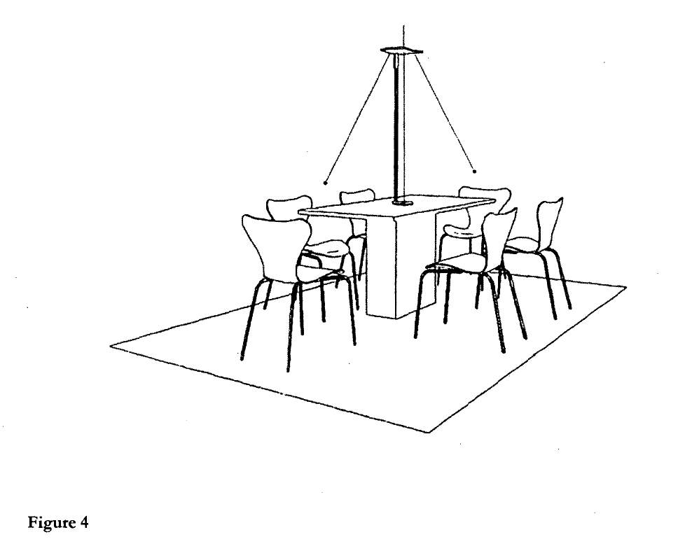

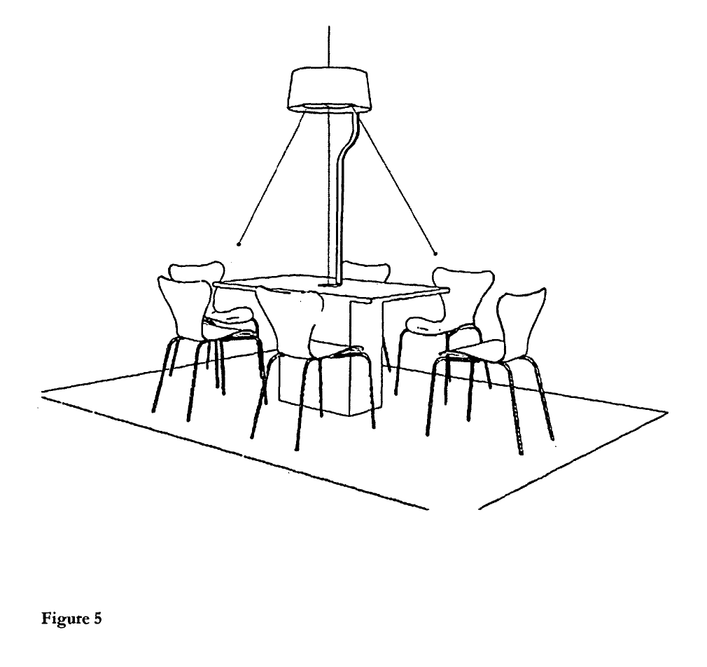

Alternatively, the imaging system can be a mirror oriented to reflect light from the projector onto the table. The projector is then mounted on the stand and positioned below the table. For example, FIG. 4 shows a unit with a projector mounted in a table; the image is again projected upwards and reflected via a mirror onto the table surface. In this instance, the mirror is mounted on a stand rising from the table, so that the combination of projector and table is self contained and semi moveable. A shade can be placed around the mirror, as shown in FIG. 5.

The table may include one or more integrated cursor control devices that are connected to the computer. The cursor control devices may be trackpads that are wirelessly connected to the computer.

The computer may be mounted under the table and it may be connected to a remote server and may also be connected to an EPOS terminal. The computer may be connected wirelessly or by cable to the remote server and EPOS terminal.

In the preferred implementation, the combined table and computer-controlled projector unit forms part of an interactive food and/or drink ordering system. The computer controlled projector projects a menu of food and/or drink selection options onto some or all of the table surface. The selection options are selectable by a user operating an interface device connected to the computer, such as a wireless track pad.

The combined table and computer-controlled projector unit needs only a power source and data connectivity to operate. Data connectivity is wireless to aid portability; it may also be cable-based.

The stand itself may include one or more rigid members to support the table and the imaging system. For example, the stand can be a single vertical rigid member mounted on a floor panel. Or the stand could include at least one rigid member to support a table and a different rigid member to support the imaging system.

Power and data cables can be routed through the floor—no need for any routing through the ceiling.

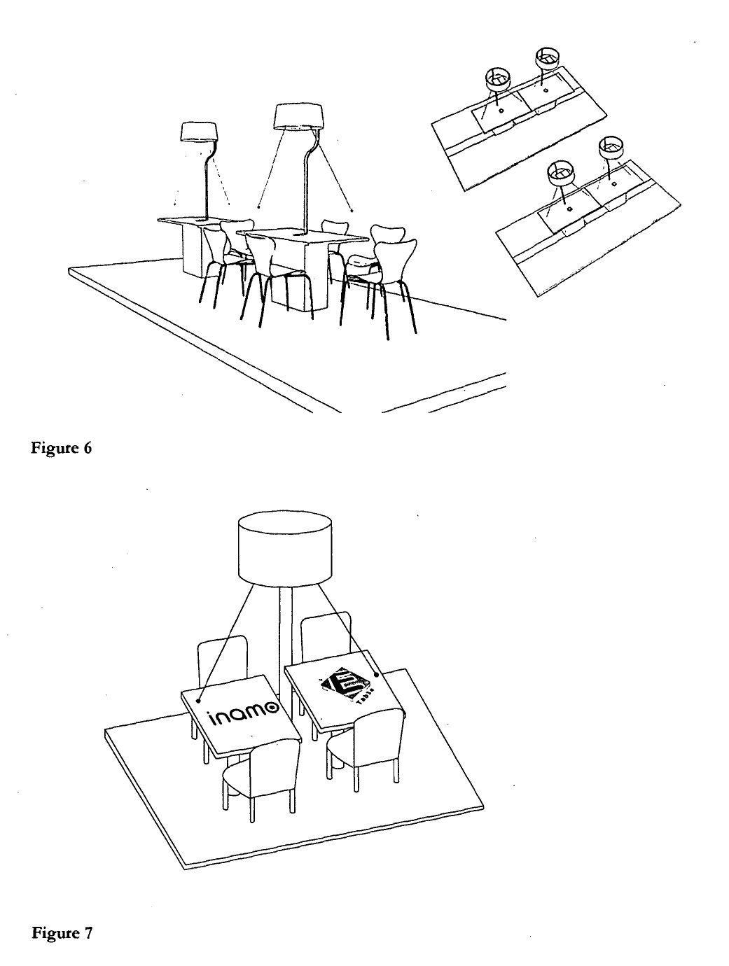

The combined table and computer-controlled projector unit may be portable in that the unit can be moved to different positions in a room or other space and does not have to be permanently installed. The combined table and computer-controlled projector unit is modular in that multiple such units can be pushed together to form a larger, combined unit, with flush fitting sides. Tables can be moved in a line as shown in FIG. 6, or can be swiveled.

For an interactive food and/or drink ordering system implementation, there are four major components: server, networking, tables (as defined in this invention) and tills.

### Server

The server component runs the e-table back end server software; the server has a redundant partner and is administered via the CMS [Content Management System] from the office PC.

### Networking

The wireless network router connects the table touch screen to the internal network via Wi-Fi. The sever Office PC and both Venta EPOS tills are physically connected to the internal network. The Venta EPOS printers are physically connected over the internal network using serial over Cat5.

### Tables

The clients (Table PC) are Windows XP embedded running on a Wyse V90L fanless computer. The video output is projected via the Canon LCD projector mounted overhead.

The table touch pads arc connected over a secured Bluetooth link, once paired the touch pads feed co-ordinate and click data to the client control panel via COM ports.

### Tills

The tills can run Venta pro EPOS and have backup partners; each till runs a printer that is physically connected using serial over cat5.

The E-table touch screen software is split into three major components: server, client and tills.

### Server

The e-table server acts as a hub for the e-table system, all e-table clients connect via the server. The server then interfaces with Venta EPOS to sell items, print bills; get pricing, product and grouping information and relays this data back to the client.

### Client

The e-table client is the customer facing interface. The E-table interface enables you to do many things including browsing the menu, order items, call for a waiter and calling for your bill.

### Tills

The tills run Venta pro EPOS. Venta EPOS is the product database and holds all product information, it is also responsible handling printing and for telling the server what tables are grouped. Venta EPOS also supplies the office PC with reporting information.

1. A combined table and computer-controlled projector unit, comprising:
(a) at least one table;
(b) a floor stand supporting the table;
(c) a projector controlled by a computer;
(d) an imaging system mounted on the stand, the imaging system causing an image to be projected onto the table.

2. The combined table and computer-controlled projector unit of claim 1 in which the imaging system is the projector, and a single floor stand supports both the table and the imaging system.

3. The combined table and computer-controlled projector unit of claim 1 in which the projector is mounted on the stand and positioned above the table.

4. The combined table and computer-controlled projector unit of claim 1 in which the imaging system is a mirror oriented to reflect light from the projector onto the table.

5. The combined table and computer-controlled projector unit of claim 4 in which the projector is mounted on the stand and positioned below the table.

6. The combined table and computer-controlled projector unit of claim 1 in which the imaging system is surrounded by a shade.

7. The combined table and computer-controlled projector unit of claim 1 in which the table includes one or more integrated cursor control devices that are connected to the computer.

8. The combined table and computer-controlled projector unit of claim 7 in which the Cursor control devices are trackpads that are wirelessly connected to the computer

9. The combined table and computer-controlled projector unit of claim 1 in which the computer is mounted under the table.

10. The combined table and computer-controlled projector unit of claim 1 in which the computer is connected to a remote server.

11. The combined table and computer-controlled projector unit of claim 1 in which the computer is connected to an EPOS terminal.

12. The combined table and computer-controlled projector unit of claim 10 in which the computer is connected wirelessly or by cable to the remote server and EPOS terminal.

13. The combined table and computer-controlled projector unit of any preceding claim 1 in which the unit forms part of an interactive food and/or drink ordering system.

14. The combined table and computer-controlled projector unit of claim 13 in which the computer controlled projector projects a menu of food and/or drink selection options onto some or all of the table surface.

15. The combined table and computer-controlled projector unit of claim 14 in which the selection options are selectable by a user operating an interface device connected to the computer, such as a wireless track pad.

16. The combined table and computer-controlled projector unit of claim 1 which is portable, in that the unit is a unitary device in which in normal use the stand, projector and imaging system are all permanently, physically connected together so that the unit is adapted to be movable to different positions in a room or other space and does not have to be permanently installed.

17. The combined table and computer-controlled projector unit of claim 1, and which needs only a power source and data connectivity to operate.

18. The combined table and computer-controlled projector unit of claim 17 in which the data connectivity is wireless.

19. The combined table and computer-controlled projector unit of claim 17 in which the data connectivity is cable-based.

20. The combined table and computer-controlled projector unit of claim 1, in which the stand includes one or more rigid members to support the table and the imaging system.

21. The combined table and computer-controlled projector unit of claim 1 in which the stand is a single vertical rigid member mounted on a floor panel.

22. The combined table and computer-controlled projector unit of claim 1, in which the stand includes at least one rigid member to support a table and a different rigid member to support the imaging system.

23. The combined table and computer-controlled projector unit of claim 1, being modular in that multiple such units can be pushed together to form a larger, combined unit, with flush fitting sides.

24. The combined table and computer-controlled projector unit of claim 1, in which power cabling is routed through the floor.

25. (canceled)
